(19) United States
(12) Patent Application Publication
(10) Pub. No.: US 2005/0130673 A1
(43) Pub. Date: Jun. 16, 2005

(54) Systems and methods for determining the position of a mobile unit

(76) Inventor: Magesh Annamalai, Renton, WA (US)

Correspondence Address: Siemens Corporation;Intellectual Property Department, 170 Wood Avenue South, Iselin, NJ, 08830, US

(21) Appl. No.: 10/987,844

(22) Filed: Nov. 12, 2004

Related U.S. Application Data
(60) Provisional application No. 60/520,023, filed on Nov. 14, 2003.

(51) Int. Cl. H04Q 7/20

(52) U.S. Cl. 455/456.2; 455/456.1

(57) ABSTRACT

Systems and methods that effectively and efficiently provide a communications interface between remotely located GMLC and SMLC nodes. A method according to the invention may include receiving a location request and location data, arranging the location request and the location data into a predefined format; calculating a position of a mobile unit; arranging data indicative of the calculated position into a predefined format; and sending the arranged data over the wireless network. A system according to the invention may include means for receiving a location request and location data; means for arranging the location request and the location data into a predefined format that is useable by a servicing mobile location center; means for calculating a position of the mobile unit; means for arranging data indicative of the calculated position into a predefined format; and means for sending the arranged data over a wireless network.

### CROSS REFERENCE TO RELATED APPLICATIONS

This application claims the benefit of United States Provisional Patent Application entitled “Method and Apparatus for Location Services Routing Between GMLC and SMLC” filed Nov. 14, 2003, Ser. No. 60/520,023 which is hereby incorporated by reference in its entirety.

### BACKGROUND OF THE INVENTION

The present invention relates generally to telecommunication systems, and more particularly to telecommunication systems that receive and process location queries from mobile units or remote applications to determine the position of a particular mobile unit within a communications network.

The Global System for Mobile Communications (GSM) is a popular standard currently in use to provide wireless communications. This standard was developed primarily for voice communications, but is also frequently used to provide data services. The General Packet Radio Service (GPRS) is an extension of the GSM standard that provides data services to GSM mobile devices. Typical applications for GPRS include Internet browsing, wireless e-mail, and text messaging.

The GSM standard is capable of providing a variety of information services to subscribers. Location Services (LCS) is one example of an information service that GSM provides. LCS allows a subscriber or remote application to obtain or determine the location of a GSM mobile unit operating within the GSM network. The location may be determined by the network, based on measurements supplied by the mobile unit, or may be determined by the mobile unit itself and communicated to the network. Various approaches to position estimation may be used, including Uplink Time of Arrival (TOA), Enhanced Observed Time Difference (E-OTD), and assisted Global Positioning System (GPS).

In a standard architecture GSM system, a centralized server known as the Serving Mobile Location Center (SMLC) manages the overall coordination and scheduling of resources required to perform the tasks associated with positioning a mobile unit. It may also calculate the final location of the mobile unit and estimate the accuracy of the position measurement. In performing these functions, the SMLC exchanges information with other entities within the network, such as the mobile unit and/or a location measuring unit or application. The location information may be the position of the mobile unit, measurements from which the position of the mobile unit may be determined, or data otherwise useful in determining the position of the mobile unit.

In a conventional GSM system, the SMLC server communicates with a Gateway Mobile Location Center (GMLC), which is typically the first point at which an external LCS client application accesses a Public Land Mobile Network (PLMN) when providing location services. The GMLC communicates the queries received from the mobile unit to the SMLC so it may perform certain positioning functions as well as provide an initial rough estimate of the mobile unit's location (such as the particular cell site the mobile unit is in).

In the past, it was common for the functionality of the SMLC and the GMLC to be combined into the same physical node. With this configuration, the SMLC and GMLC applications would typically communicate directly with one another according to standard SS7 communication techniques. However, recently, as communication networks have become more distributed in nature, it is becoming more common for the SMLC and the GMLC to be physically remote from one another.

Accordingly what is needed is an efficient and effective way for an SMLC node to interface with a physically remote GMLC node and vice versa.

In view of the foregoing, it would therefore be desirable to provide systems and methods that effectively and efficiently provide a communications interface between remotely located GMLC and SMLC nodes.

### SUMMARY OF THE INVENTION

It is therefore an object of the present invention to provide systems and methods that effectively and efficiently provide a communications interface between remotely located GMLC and SMLC nodes.

These and other objects of the invention are provided in accordance with the principles of the present invention by providing systems and methods that effectively and efficiently provide a communications interface between remotely located GMLC and SMLC nodes. A method according to a preferred embodiment of the invention may include receiving a location request and location data at a public land mobile network. The public land mobile network may include a servicing mobile location center and a gateway mobile location center. The method may also include arranging the location request and the location data into a predefined format that is useable by the servicing mobile location center; calculating a position of the mobile unit using the servicing mobile location center and/or the gateway mobile location center; arranging data indicative of the calculated position into a format recognizable by the mobile unit, the location application, and/or the location client; and sending the arranged data over the wireless network to the mobile unit, the location application, and/or the location client.

A system according to a preferred embodiment of the present invention may include means for receiving a location request and location data; means for arranging the location request and the location data into a predefined format that is useable by a servicing mobile location center; means for calculating a position of the mobile unit; means for arranging data indicative of the calculated position into a format recognizable by the mobile unit, a location application, and/or a location client; and means for sending the arranged data over a wireless network to the mobile unit, the location application, and/or the location client.

### BRIEF DESCRIPTION OF THE DRAWINGS

The above and other objects and advantages of the present invention will be apparent upon consideration of the following detailed description, taken in conjunction with the accompanying drawings, in which like reference numbers refer to like parts throughout, and in which:

FIG. 1 shows a generalized block diagram of a system constructed in accordance with the principles of preferred embodiments of the present invention for providing a communications interface between remotely located GMLC and SMLC nodes.

FIG. 2 is a block diagram illustrating an alternate preferred embodiment of the system shown in FIG. 1.

FIG. 3 is flow chart illustrating some of the steps involved in providing a communications interface between remotely located GMLC and SMLC nodes in accordance the principles of preferred embodiments of the present invention.

### DETAILED DESCRIPTION OF THE INVENTION

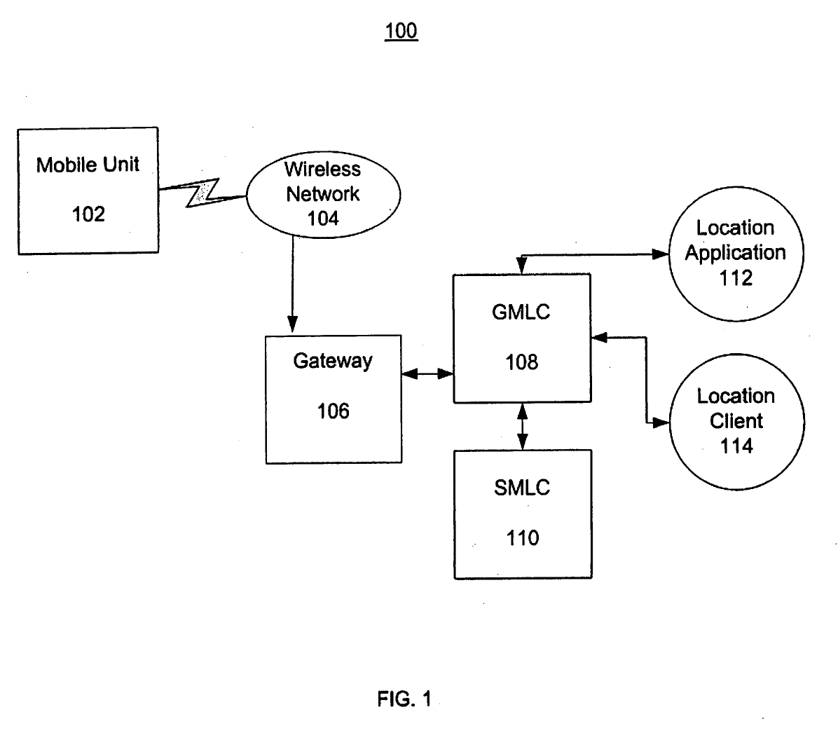

FIG. 1 shows a generalized block diagram of a system 100 for providing a communications interface between a remotely located GMLC node 108 and an SMLC node 110. The system may include a mobile unit 102, a wireless communications network 104 which is capable of operating according to a particular communications standard (e.g., GSM), a gateway interface 106 capable of interfacing with wireless communications network 104, a location application 112, and a location client 114.

In operation, mobile unit 102, which may be any suitable mobile communications device such as a cellular telephone, a personal digital assistant (PDA), a handheld PC, a Blackberry™, etc. may issue a position or location request to wireless communication network 104. Network 104, which preferably includes GSM and GPRS communication capabilities, receives this request and communicates it to gateway 106 which may function as interface between wireless communication network 104 and the components typically found incertain portions of a Public Land Mobile Network (PLMN). In some embodiments, the PLMN may include GMLC 108, SMLC 110, location application 112 as well as other known telecommunications components (not shown).

Generally speaking, wireless network 104 includes the resources required to support GPRS functions. Moreover, in some embodiments, network 104 may provide network access control, which is the means by which a user of mobile unit 102 connects to a telecommunications network in order to use the services of that network.

Gateway 106 may include software and/or hardware that allows it to function as a Wireless Application Gateway (WAP) and may also include similar resources or otherwise be configured to allow it to provide Push Proxy Gateway (PPG) functions. However, it will be understood that any other suitable methods, communication or data transfer standards, or other protocols may be used, if desired, by gateway 106 to communicate with wireless network 104.

Location application 112 may be any commercial or proprietary application or system suitable for assisting in determining the position of mobile unit 102. For example, location application 112 may include or communicate with certain location systems that employ Global Positioning System (GPS) measurements or other observation or measurement-based techniques such as Uplink Time of Arrival (TOA), Enhanced Observed Time Difference (E-OTD), suitable for providing information to SMLC 110 or any other system in order to assist in locating mobile unit 102.

Location client 114 may be any suitable external client process requesting location information regarding mobile unit 102. For example, location client 114 may be a software tracking application that informs users of the location of a particular mobile unit 102.

As shown in system 100 of FIG.1, gateway 106 may send location requests to location application 112 via GMLC 108 and SMLC 110. In some embodiments, this request may include location data such as pseudo-range measurements from mobile unit 102 that provides an approximation of where the particular mobile unit is located within a particular cell site. This location data may also be used to aid in the calculation of a more precise location of the mobile unit's position. As state above, this information may be used to approximate the location of mobile unit 102 without further processing by location application 112, location client 114, or SMLC 110 and may be useful in emergency situations when subsequent communications with mobile unit 102 is lost.

In the embodiment of FIG. 1, location application 112 and/or location client 114 may interface directly (or through some intermediate circuitry (not shown)) with GMLC 108 to coordinate the positioning and control transactions with SMLC 110 necessary to complete a location request. This may be accomplished using some of the positioning and control messages discussed below. Subsequently, GMLC 108 may communicate the results of these transactions to mobile unit 102, location application 112, and/or location client 114 thereby providing the requested location information/data. Such information/data may be integrated into a mapping application available to mobile unit 102, location application 112, and/or location client 114 such that the location information makes sense to the user (discussed in more detail below).

In other embodiments, location application 112 and/or location client 114 may be external application requesting the location information from mobile unit 102. In this case, the request may be processed generally as described above with GMLC 108 and SMLC 110 performing the location calculations (with or without information/data from mobile device 102) with the results being provided to application 112 and/or client 114.

Some of the positioning and control messages that may be used for GMLC 108 to communicate with a remotely located SMLC 110 (and vice versa) in accordance with the principles of a preferred embodiment of the present invention include the following:

RSP Positioning Messages:
RSP Perform_Location_Request
RSP Perform_Location_Response
RSP Perform_Location_Abort
RSP Measure_Position_Request
RSP Measure_Position_Response
RSP Reset
RSP Abort
RSP Reject

In some embodiments, RSP positioning messages may have the following structure:

```
    Message Begin Flag
    1 byte = 0xFF
    Message Length Field
1 byte = lengths of the message after this field
RSP Positioning Message Type: (1 byte)
RSP Perform Location Request,
RSP Perform Location Response,
Abort, Reset, Protocol_Error,
Termination
    Transaction Identifier (6 bytes)
    Information Elements/Data
```

RSP Control Messages:
RSP_Appication_context_req
RSP_Appication_context_res
RSP_Application_check_alive
RSP_Application_check_alive_ack
RSP_Protocol_Error

In some embodiments, RSP control messages may have the following structure:

```
    Message Begin Flag
    1 byte = 0xFF
    Message Length Field
1 byte = lengths of the message after this field
RSP Control Message Type: (1 byte)
RSP_Application_Context
RSP_Application_Context_Response
RSP_Check_Alive
RSP_Check_Alive_Ack
    Information Elements/Data
```

The set of messages and the message structures listed above may be thought of as defining a new communication protocol that may sometimes be referred to as the Remote SMLC Protocol (RSP). Some or all of the above messages (and any results or computations associated therewith) may be transported back and forth between remotely located GMLC and SMLC nodes, thus providing an effective and efficient way for these platforms to communicate and cooperate with one another in providing location services to a mobile unit despite being physically separate from one another.

System 100 may be configured such that the messages and structures shown above may be native to both GMLC 108 and SMLC 110 or may require some intermediate processing to be understood by one or both of these processes. In the case where intermediate processing is required, e.g., such as when certain legacy systems are updated, either SMLC 110 or GMLC 108 may be reprogrammed to convert or accept the RSP messages above, or in some embodiments, may require the installation of translation or conversion hardware/software to convert these messages to a desired format (not shown).

In addition, in some embodiments of the present invention, standardized GPRS position and control messages may be converted into the RSP messages above by using the information contained within the messages themselves and rearranging information into the new format as shown in the illustrative examples below:

| Standard Positioning Messages | Corresponding RSP messages |
|---|---|
| Perform_location_request | RSP Perform_location_request |
| (BSSMAP-LE) | |
| Perform_location_response | RSP Perform_location_response |
| (BSSMAP-LE) | |
| RRLP Measure_position_request | RSP Measure_position_request |
| RRLP Measure_position_response | RSP Measure_position_response |

Additional illustrative message arrangements and formats may be as follows:

3.1.1.1 RSP Perform Location Request message

| Information | | | | Length in |
|---|---|---|---|---|
| element | Type/Reference | Presence | Format | octets |
| Message type | See 0 | M | V | 1 |
| Transaction_ID | See 0 | M | V | 6 |
| Location Type | 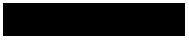 | M | TLV | 3-4 |
| Cell Identifier | 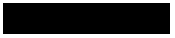 | M | TLV | 3-10 |
| Classmark Information Type 3 | 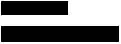 | O | TLV | 2-n |
| LCS Client Type | 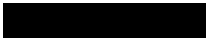 | C | TLV | 3 |
| Chosen Channel | 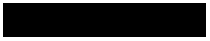 | O | TLV | 2-n |
| LCS Priority | 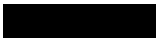 | O | TLV | 3 |
| LCS QoS | 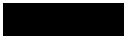 | O | TLV | 6 |
| GPS Assistance Data | 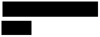 | O | TLV | 3-n |
| BSSLAP APDU | 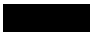 | O | TLV | 2-n |
| Response Time | See 0 | O | TV | 2 |
| Generic | See 0 | O | TLV | 3-n |
| Information | | | | |

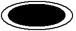

Ref: BSSMAP-LE spec Rel ′99 49.031 v 8.6.0 Sec 9.1.1-9.1.8

3.1.1.2 RSP Perform Location Response message

| Information | | | | Length in |
|---|---|---|---|---|
| element | Type/Reference | Presence | Format | octets |
| Message type | See 0 | M | V | 1 |
| Transaction_ID | See 0 | M | V | 6 |
| Location Estimate | 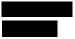 | C | TLV | 2-22 |
| Positioning Data | 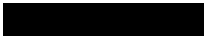 | O | TLV | 2-n |
| Deciphering Keys | 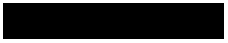 | O | TLV | 17 |
| LCS Cause | 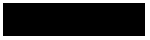 | O | TLV | 3 |

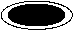

Ref: BSSMAP-LE spec Rel′99 49.031 v 8.6.0 Sec 9.2.1-9.2.4

3.1.1.3 RSP Measure Position Request—Message coding is similar to the RRLP measure position request with additional parameters specifying the RSP Measure Position Request message type and the transaction ID.
3.1.1.4 RSP Measure Position Response—Message coding is similar to the RRLP measure position response with additional parameters specifying the RSP Measure Position Response message type and the transaction ID.

3.1.1.5 RSP Perform Location Abort/Reset Message

| | | | | Length in |
|---|---|---|---|---|
| Information element | Type/Reference | Presence | Format | octets |
| Message type | See 0 | M | V | 1 |
| Transaction_ID | See 0 | M | V | 6 |
| Cause | See 0 | M | TV | 2 |

3.1.1.6 RSP PROTOCLO ERROR Message

| Information | Type/ | | | |
|---|---|---|---|---|
| element | Reference | Presence | Format | Length |
| Message Type | See 0 | M | V | 1 |
| Transaction_{—} | See 0 | M | V | 6 |
| ID | | | | |
| Transaction | See 0 | M | TV | 2 |
| Error Cause | | | | |
| User | See 0 | O | TLV | 3 − n |
| information | | | | |

3.1.1.7 RSP TERMINATION Message

| Information | Type/ | | | |
|---|---|---|---|---|
| element | Reference | Presence | Format | Length |
| Message Type | See 0 | M | V | 1 |
| Transaction_{—} | See 0 | M | V | 6 |
| ID | | | | |
| Termination | See 0 | M | TV | 2 |
| Cause | | | | |

3.1.2 RSP Control Messages

3.1.2.1 RSP APPLICATION CONTEXT Message

| Information | Type/ | | | |
|---|---|---|---|---|
| element | Reference | Presence | Format | Length |
| Message Type | See 0 | M | V | 1 |
| Application ID | See 0 | M | TV | 2 |

3.1.2.2 RSP APPLICATION CONTEXT RESPONSE Message

| Information | Type/ | | | |
|---|---|---|---|---|
| element | Reference | Presence | Format | Length |
| Message Type | See 0 | M | V | 1 |
| Context Status | See 0 | M | TV | 2 |

3.1.2.3 RSP CHECK ALIVE Message

| Information | Type/ | | | |
|---|---|---|---|---|
| element | Reference | Presence | Format | Length |
| Message Type | See 0 | M | V | 1 |

3.1.2.4 RSP CHECK ALIVE ACK Message

| Information | Type/ | | | |
|---|---|---|---|---|
| element | Reference | Presence | Format | Length |
| Message Type | See 0 | M | V | 1 |

3.1.3 Coding of New Message Type on RSP

| 8 7 6 5 4 3 2 1 | Message Type |
|---|---|
| 0 0 0 0 0 0 0 1 | RSP Perform Location Request message |
| 0 0 0 0 0 0 1 0 | RSP Perform Location Response |
| 0 0 0 0 0 0 1 1 | RSP Measure Position Request |
| 0 0 0 0 0 1 0 0 | RSP Measure Position Response |
| 0 0 0 0 0 1 0 1 | RSP Abort |
| 0 0 0 0 0 1 1 0 | RSP RESET |
| 0 0 0 0 0 1 1 1 | RSP PROTOCOL ERROR |
| 0 0 0 0 1 0 0 0 | RSP TERMINATION |
| 0 0 0 0 1 0 0 1 | Reserved |
| to | |
| 0 1 1 1 1 1 1 1 | |
| 1 0 0 0 0 0 0 1 | RSP APPICATION CONTEXT |
| 1 0 0 0 0 0 1 0 | RSP APPICATION CONTEXT RESPONSE |
| 1 0 0 0 0 0 1 1 | RSP CHECK ALIVE |
| 1 0 0 0 0 1 0 0 | RSP CHECK ALIVE ACK |
| 1 0 0 0 0 1 0 1 | Reserved |
| to | |
| 1 1 1 1 1 1 1 1 | |

3.1.4 Coding of Information Element on RSP

3.1.4.1 Element Identifier

| Element | |
|---|---|
| Identifier | |
| Coding | Element name |
| 0000 0000 | Reserved |
| 0000 0001 | Location Type |
| 0000 0010 | Cell Identifier |
| 0000 0011 | Classmark Information Type 3 |
| 0000 0100 | LCS Client Type |
| 0000 0101 | Chosen Channel |
| 0000 0110 | LCS Priority |
| 0000 0111 | LCS QoS |
| 0000 1000 | GPS Assistance Data |
| 0000 1001 | BSSLAP APDU |
| 0000 1010 | Location Estimate |
| 0000 1011 | Positioning Data |
| 0000 1100 | Deciphering Keys |
| 0000 1101 | LCS Cause |
| 0000 1110 | Cause |
| 0000 1111 | Application ID |
| 0001 0000 | Context Status |
| 0001 0001 | Transaction Error Cause |
| 0001 0010 | User Info |
| 0001 0011 | Termination Cause |
| 0001 0100 | Generic Information |
| 0001 0101 | Reserved |
| to | |
| 1111 1111 | |

3.1.4.2 Transaction_ID

| | | | | | | | |
|---|---|---|---|---|---|---|---|
| 8 | 7 | 6 | 5 | 4 | 3 | 2 | 1 |

| | |
|---|---|
| Transaction ID value | octet 1 |
| continue | octet 2 |
| continue | octet 3 |
| continue | octet 4 |
| continue | octet 5 |
| continue | octet 6 |

Possible range of Transaction ID value:
00 00 00 00 00 00 to FF FF FF FF FF FF

3.1.4.3 Response Time

| | | | | | | | |
|---|---|---|---|---|---|---|---|
| 8 | 7 | 6 | 5 | 4 | 3 | 2 | 1 |

| | |
|---|---|
| Element identifier, see 0 | octet 1 |
| Timer Value | octet 2 |

The Timer Value field is expressed in units of 500 ms.

3.1.4.4 Application ID

| | | | | | | | |
|---|---|---|---|---|---|---|---|
| 8 | 7 | 6 | 5 | 4 | 3 | 2 | 1 |

| Element identifier, See 0 | | octet 1 |
|---|---|---|
| Application ID | Version | octet 2 |

Coding of Application ID (bits 8-3):
000001 A-GPS Application
The Version field (bits 2-1) shall be coded as 00 if not used. If used, it shall be populated with the value assigned by the PDE.

3.1.4.5 Context Status

| | | | | | | | |
|---|---|---|---|---|---|---|---|
| 8 | 7 | 6 | 5 | 4 | 3 | 2 | 1 |

| | |
|---|---|
| Element identifier, See 0 | Octet 1 |
| Status | Octet 2 |

Coding of Status (bits 8-1):

| | |
|---|---|
| 00000000 | Reserved |
| 00000001 | Allow |
| 00000010 | Not Allow |
| 00000011 | Not Supported |
| 00000100 | Reserved |
| to | |
| 11111111 | |

3.1.4.6 Transaction Error Cause

3.1.4.6 Transaction Error Cause

| | | | | | | | |
|---|---|---|---|---|---|---|---|
| 8 | 7 | 6 | 5 | 4 | 3 | 2 | 1 |

| | |
|---|---|
| Element identifier, See 0 | octet 1 |
| Cause | octet 2 |

Coding of Cause (bits 8-1):

| | |
|---|---|
| 00000000 | Reserved |
| 00000001 | Unknown Transaction |
| 00000010 | Duplicated Transaction ID |
| 00000011 | Message Synchronization Lost |
| 00000100 | Message Rejected |
| 00000101 | Invalid Message |
| 00000110 | Badly coded Message |
| 00000111 | Reserved |
| to | |
| 11111111 | |

3.1.4.7 User Information IE

| | | | | | | | |
|---|---|---|---|---|---|---|---|
| 8 | 7 | 6 | 5 | 4 | 3 | 2 | 1 |

| | |
|---|---|
| Element identifier, See 0 | octet 1 |
| Length | octet 2 |
| The rest of the octet contains User | octets 3 − n |
| Information data | |

3.1.4.8 Cause IE

| | | | | | | | |
|---|---|---|---|---|---|---|---|
| 8 | 7 | 6 | 5 | 4 | 3 | 2 | 1 |

| | |
|---|---|
| Element identifier, See 0 | octet 1 |
| Cause value | octet 2 |

The cause field is coded as follows:

| | |
|---|---|
| 0000 0000 | Reserved |
| 0000 0001 | Congestion |
| 0000 0010 | System Failure |
| 0000 0011 | Protocol Error |
| 0000 0100 | Data missing in the |
| | positioning request |
| 0000 0101 | Location request |
| | aborted |
| 0000 0110 | Unexpected data value |
| | in position request |
| 0000 0111 | unspecified |
| 0000 1000 | Failure or Error in |
| | GMLC |

All unassigned codes are spare.

3.1.4.9 Termination Cause IE

| | | | | | | | |
|---|---|---|---|---|---|---|---|
| 8 | 7 | 6 | 5 | 4 | 3 | 2 | 1 |

| | |
|---|---|
| Element identifier, See 0 | octet 1 |
| Cause value | octet 2 |

The cause field is coded as follows:

| | |
|---|---|
| 0000 0000 | Reserved |
| 0000 0001 | Normal - unspecified |
| 0000 0010 | System Reset |

All unassigned codes are spare.

3.1.4.10 Generic Information IE

| | | | | | | | |
|---|---|---|---|---|---|---|---|
| 8 | 7 | 6 | 5 | 4 | 3 | 2 | 1 |

| | |
|---|---|
| Element identifier, See 0 | octet 1 |
| Length | octet 2 |
| The rest of the octet contains | Octet 3 − n |
| generic information data | |

4.0 Abbreviations

| | |
|---|---|
| 3GPP | Third Generation Partnetship Oroject |
| BSC | Base Station Controller |
| BSSLAP | BSS LCS Assistance Protocol |
| BSSMAP-LE | BSS Management Application Part LCS |
| | Extension |
| CR | Change Request |
| IE | Information Element |
| IEI | Information Element Identifier |
| IP | Internet Protocol |
| Lb | Interface between SMLC and BSC |
| LCS | Location Service |
| MS | Mobile Station |
| QoS | Quality of Service |
| SCCP | Signaling Connection Control Part |
| SMLC | Serving Mobile Location Centre |
| T | (IE format) Type |
| TCP | Transmission Control Protocol |
| TLV | (IE format) Type, Length and value |
| TS | Technical Specification |
| TV | (IE format) Type and value |
| V | (IE format) Value only |

The following references are hereby incorporated by reference in their entirety.

| | |
|---|---|
| /1/ | 3GPP TS 43.059 |
| /2/ | RFC793, Transmission Control Protocol |
| /3/ | TS 09.031 v6.0.0 or latest: “Base Station System |
| | Application Part; LCS Extension (BSSAP-LE)” |
| /4/ | TS 04.031 RRLP |
| /5/ | TS 03.71 |

Returning now to FIG. 1, in system 100, SMLC 110 may include all or most of the functionality required to support location services (LCS). Furthermore, SMLC 110 may manage the overall coordination and scheduling of resources required to perform positioning of a mobile unit 102 and may, in some instances, be referred to as a location server. SMLC 110 may perform the steps necessary to calculate a final location estimate of the mobile unit 102 and the accuracy thereof using known calculation techniques.

GMLC 108 may also include some of the functionality required to support location services. In some embodiments, GMLC 108 is the first node at which location application 112 and/or location client 114 accesses wireless network 104. GMLC 108 may perform certain managerial functions associated with signal routing such as request process signal routing information from a home location register to determine how to route response to locations queries and may assist in calculating the final location of mobile unit 102.

In one embodiment of the present invention, GMLC 108 and SMLC-llO may communicate with one another using a TCP/IP or Ethernet connection that may be initiated by GMLC 108 acting as a client and SLMC 110 acting as a server. When the communication session is established, an application level handshake may be required to ensure that both platforms are communicating with the correct application. A successful handshake may create an RPS interface link in which a mobile unit location related transaction can proceed.

One TCP/IP session may constitute one RPS interface link. In some embodiments, GMLC 108 may establish more than one communication session to create multiple RPS interface links. In this case, each link may be created by successful application level handshaking. A communications session may terminate if either GMLC 108 or SMLC 110 does not receive a status communication from the other within a predetermined period of time (e.g., 30 seconds).

In one embodiment of the present invention, RSP messages relating to the same positioning transaction may be sent and received over the same RSP interface link if multiple such links are active. This may be done to prevent information from these RSP messages from being intermixed in the TCP/IP byte stream.

Information processed by SMLC 110 and GMLC 108 in accordance with the RPS standard disclosed herein may be converted back into standard GPRS format at GMLC 108 or gateway 106 for transmission of requested information back to mobile unit 102 via wireless network 104. This alleviates the need to update mobile units 102 or other portions of the wireless network 104 to recognize RSP messages. Moreover, GMLC 108, SMLC 110, and mobile unit 102 may include or communicate with or include a mapping application program such as Mapquest™ to further process the position information requested into a map type or other format for ease of comprehension by the user.

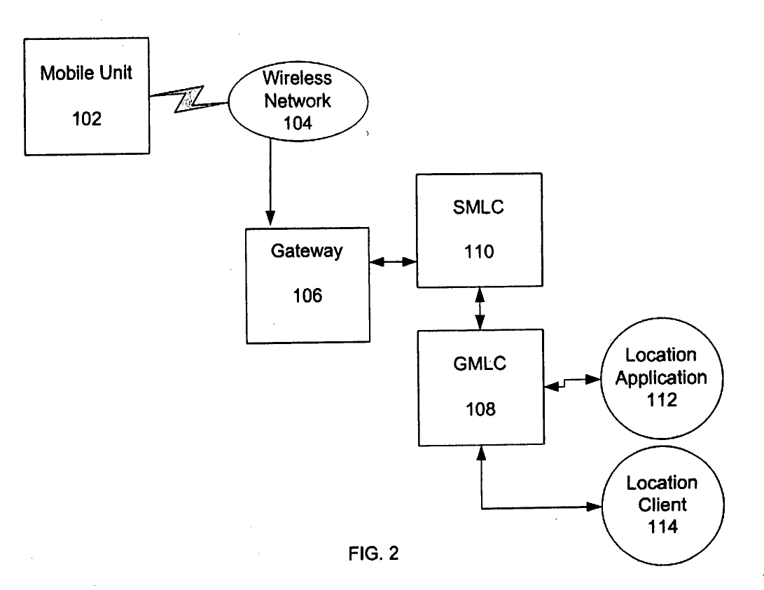

FIG. 2 illustrates an alternate embodiment of the present invention wherein gateway 106 interfaces directly with SMLC 110 rather than through GMLC 108. With this configuration, SMLC 110 receives location requests from GMLC 108 using the RSP messages described above and SMLC 110 connects to gateway 106. SMLC 110 may convert the RSP messages back into GPRS format and transmit them to mobile unit 102 through gateway 106 and wireless network 104.

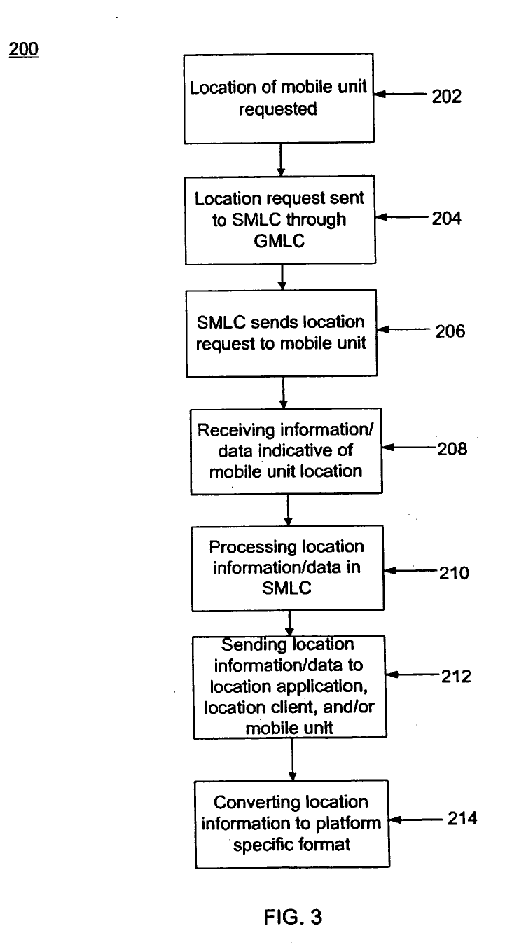

Flow chart 200 in FIG. 3 shows some of the steps involved in providing location information to mobile unit 102, application 112, or client 114 in accordance with the principles of the present invention. At step 202, the location of mobile unit 102 may be requested. This request may come from mobile unit 102, location application 112, and/or location client 114 depending on the particular implementation in use. Next, at step 204, the location request may be routed to SMLC 110 via GMLC 108. However, in some embodiments, SMLC 110 may receive the location request from gateway 106 directly (if from mobile unit 102) or from GMLC 108 (if from location application 112 or location client 114 (e.g., see FIG. 2)).

At step 206 SMLC 110 may send a location request to mobile unit 102 such as GPS or other positioning system information. In response to receiving such information, mobile unit 102 may send information/data generally indicative of its position (such as psuedo-range information) back to SMLC 110 at step 208. Next, SMLC 110 may process this information, possibly along with other positioning information received from an external source, to determine the location of mobile unit 102 at step 210. At step 212, this location information may be sent to external application and/or clients such as, for example, mobile unit 102, location application 112, and/or location client 114. Next, at step 214, before final transmission to its destination, the location information/data may be converted or mapped from and internal SMLC/GMLC communication format such as the format disclosed herein to standard GPRS, GSM CDMA or other communication format for processing by that application/client.

Thus, systems and methods for locating and communicating location information to a mobile unit are provided. It will be understood that the foregoing is only illustrative of the principles of the invention and that various modifications can be made by those skilled in the art without departing from the scope and spirit of the invention. Accordingly, such embodiments will be recognized as within the scope of the present invention.

Persons skilled in the art will appreciate that the present invention can be practiced by other than the described embodiments, which are presented for purposes of illustration rather than of limitation and that the present invention is limited only by the claims that follow.

1. A method for providing data indicative of a location of a mobile unit, comprising:
receiving a location request and location data at a public land mobile network, wherein the public land mobile network includes a servicing mobile location center and a gateway mobile location center;
arranging the location request and the location data into a predefined format that is useable by the servicing mobile location center;
calculating a position of the mobile unit using at least one of the servicing mobile location center and the gateway mobile location center, wherein the calculating is based at least in part on the location data;
arranging data indicative of the calculated position into a format recognizable by at least one of 1) the mobile unit, 2) the location application, and 3) the location client; and
sending the arranged data over the wireless network to at least one of 1) the mobile unit, 2) the location application, and 3) the location client.

2. The method of claim 1, wherein the arranging the location request and location data into a predefined format includes establishing at least one transmission control protocol connection between the gateway mobile location center and the servicing mobile location center.

3. The method of claim 1, wherein the arranging the location request and location data into a predefined format includes mapping standard positioning messages to a platform specific protocol.

4. The method of claim 3, wherein the mapping of standard positioning messages to a platform specific protocol includes mapping standardized positioning messages to a Remote Servicing Mobile location Center Protocol.

5. The method of claim 1, wherein the arranging of data indicative of the calculated position into a format recognizable by at least one of 1) the mobile unit, 2) the location application, and 3) the location client includes mapping a platform specific format to a standardized format.

6. The method of claim 5, wherein mapping a platform specific format to a standardized format further includes mapping a Remote Servicing Mobile location Center Protocol to a standardized message format.

7. A method for providing location data indicative of the location of a mobile unit, comprising:
sending a location request and location data via a wireless network using at least one of 1) a mobile unit, 2) a location application, and 3) a location client;
receiving the location request and the location data at a public land mobile network, wherein the public land mobile network includes a servicing mobile location center and a gateway mobile location center;
arranging the location request and the location data into a predefined format that is readable by the servicing mobile location center;
calculating a position of the mobile unit using at least one of the servicing mobile location center and the gateway mobile location center, wherein the calculation is based at least in part on the location data;
arranging data indicative of the calculated position into a format recognizable by at least one of 1) the mobile unit, 2) the location application, and 3) the location client;
sending the arranged data over the wireless network to at least one of 1) the mobile unit, 2) the location application, and 3) the location client; and
receiving the calculated data on at least one of 1) the mobile unit, 2) the location application, and 3) the location client.

8. The method of claim 7, wherein the arranging the location request and location data into a predefined format includes establishing at least one transmission control protocol connection between the gateway mobile location center and the servicing mobile location center.

9. The method of claim 7, wherein the arranging the location request and location data into a predefined format includes mapping standard positioning messages to a platform specific protocol.

10. The method of claim 9, wherein the mapping of standard positioning messages to a platform specific protocol includes mapping standardized positioning messages to a Remote Servicing Mobile location Center Protocol.

11. The method of claim 7, wherein the arranging of data indicative of the calculated position into a format recognizable by at least one of 1) the mobile unit, 2) the location application, and 3) the location client includes mapping a platform specific format to a standardized format.

12. The method of claim 11, wherein mapping a platform specific format to a standardized format further includes mapping a Remote Servicing Mobile location Center Protocol to a standardized message format.

13. A system for providing data indicative of a location of a mobile unit, comprising:
means for receiving a location request and location data;
means for arranging the location request and the location data into a predefined format that is useable by a servicing mobile location center;
means for calculating a position of the mobile unit, wherein the calculating is based at least in part on the location data;
means for arranging data indicative of the calculated position into a format recognizable by at least one of 1) the mobile unit, 2) a location application, and 3) a location client; and
means for sending the arranged data over a wireless network to at least one of 1) the mobile unit, 2) the location application, and 3) the location client.

14. The system of claim 13, wherein the means for arranging the location request and location data into a predefined format includes means for establishing at least one transmission control protocol connection between the gateway mobile location center and the servicing mobile location center.

15. The method of claim 13, wherein the means for arranging the location request and location data into a predefined format includes means for mapping standard positioning messages to a platform specific protocol.

16. The method of claim 15, wherein the means for mapping of standard positioning messages to a platform specific protocol includes means for mapping standardized positioning messages to a Remote Servicing Mobile location Center Protocol.

17. The method of claim 13, wherein the means for arranging of data indicative of the calculated position into a format recognizable by at least one of 1) the mobile unit, 2) the location application, and 3) the location client includes means for mapping a platform specific format to a standardized format.

18. The method of claim 17, wherein means for mapping a platform specific format to a standardized format further includes means for mapping a Remote Servicing Mobile location Center Protocol to a standardized message format.
